(19) United States
(12) Patent Application Publication
(10) Pub. No.: US 2019/0100609 A1
(43) Pub. Date: Apr. 4, 2019

(54) BUTENE-1 POLYMER IN MASTERBATCH, CONCENTRATE, AND COMPOUNDING APPLICATIONS

(71) Applicant: BASELL POLIOLEFINE ITALIA S.R.L., Milano (IT)

(72) Inventors: TIMOTHY S. SCHLOEMER, CINCINNATI, OH (US); GIANLUCA MUSACCHI, MILANO (IT); ANKUR RASTOGI, ESCHBORN (DE)

(73) Assignee: BASELL POLIOLEFINE ITALIA S.R.L., MILANO (IT)

(21) Appl. No.: 16/150,905

(22) Filed: Oct. 3, 2018

Related U.S. Application Data
(60) Provisional application No. 62/567,559, filed on Oct. 3, 2017.

(51) Int. Cl. C08F 110/06; C08K 5/00; C08K 3/22; C08F 110/08; C08J 3/22

(52) U.S. Cl. CPC C08F 110/06; C08K 2003/2241; C08K 3/22; C08F 110/08; C08J 3/226; C08K 5/005; C08K 5/0075; C08F 2500/12; C08F 2500/07; C08F 2500/15; C08J 2323/12; C08J 2323/20; C08F 2800/20; C08K 2201/005; C08K 5/0041

(57) ABSTRACT

One or more 1-butene polymers and uses thereof. The 1-butene polymer may be used as a viscosity modifier, flexibilizer, dispersing aid, and/or impact modifier for polymer compositions, such as those including polypropylene. The 1-butene polymer may also be used as a carrier for additives, such as fluorinated additives. Articles may be made that include the 1-butene polymer, polypropylene, and pigments.

### CROSS-REFERENCE TO RELATED APPLICATIONS

This application is the Non-Provisional Patent Application, which claims benefit of priority to U.S. Provisional Application No. 62/567,559, filed Oct. 3, 2017, the contents of which are incorporated herein by reference in their entirety.

### FIELD OF THE INVENTION

The present disclosure relates to 1-butene polymers, 1-butene polymer compositions, and applications of and for 1-butene polymers. The 1-butene polymer compositions disclosed herein may be used in masterbatch, concentrate, and/or compounding applications.

### BACKGROUND OF THE INVENTION

1-Butene polymers (i.e., Polybutene-1) (PB-1) polymers are commercially significant, and may be used in a number of applications, including, but not limited to, packaging, films, hot melt adhesives, polyolefin modification(s), hot water tanks, pipes, fittings, etc. PB-1 compositions, such as those available from LyondellBasell Industries, are light weight and may have excellent performance characteristics, including, but not limited to, outstanding creep resistance and/or flexibility over a wide temperature range, low noise transmission, and/or good heat fusion properties.

There remains a need, however, for new or improved PB-1 polymers and compositions that may have one or more improved properties, such as alternative and/or enhanced physicochemical properties. The new or improved PB-1 polymers and compositions may be used in new applications, and/or meet certain commercial and legal requirements. The new or improved PB-1 polymers may be used in or as automotive parts, food packaging, films, tubing, caps and closures, gaskets, hot water heater liners, hot melt adhesives, compounding and masterbatches, fibers, sealants, purging compounds, and/or piping systems.

### SUMMARY OF THE INVENTION

Provided herein are new or improved PB-1 polymers and compositions. The PB-1 polymers and compositions provided herein may have one or more alternative and/or enhanced physicochemical properties. Also provided herein are methods of improving one or more properties of a polymer composition.

In one aspect, provided herein are compositions that, in some embodiments, include a 1-butene polymer, a pigment, and a polypropylene, wherein the 1-butene polymer is present in the composition at an amount of about 5% to about 20% by weight, based on the weight of the composition, wherein the pigment is present in the composition at an amount of about 10% to about 45% by weight, based on the weight of the composition, and wherein the polypropylene is present in the composition at an amount of about 25% to about 85% by weight, based on the weight of the composition. In some embodiments, the pigment is in a particulate form having an average particle size of about 5 μm to about 55 μm.

In another aspect, methods of modifying the viscosity of a polymer composition are provided. In some embodiments, the methods include providing a polymer composition comprising polypropylene, wherein the polymer composition has a first viscosity; and contacting the polymer composition with a 1-butene polymer to form a modified polymer composition having a second viscosity; wherein the first viscosity and the second viscosity are different. The contacting of the polymer composition with the 1-butene polymer may include combining and extruding the polymer composition and the 1-butene polymer. The 1-butene polymer may be an impact modifier; and the polymer composition may have a first durability, the modified polymer composition may have a second durability, and the first durability and the second durability may be different. The 1-butene polymer may be a flexibilizer; and the polymer composition may have a first flexibility, the modified polymer composition may have a second flexibility, and the first flexibility and the second flexibility may be different.

In another aspect, methods of dispersing a pigment and/or filler in a polymer composition are provided. In some embodiments, the methods include providing a polymer composition comprising a pigment, a filler, or a combination thereof; and contacting the polymer composition with a non-blooming dispersion aid to form a modified polymer composition, wherein the non-blooming dispersion aid comprises a 1-butene polymer; wherein the polymer composition has one or more surface characteristics that are substantially identical to one or more surface characteristics of the modified polymer composition.

In yet another aspect, methods of modifying a polymer composition are provided. In some embodiments, the methods include providing a polymer composition comprising a pigment, a filler, or a combination thereof, wherein the pigment, the filler, or a combination thereof have a first propensity to agglomerate; contacting the polymer composition with a 1-butene polymer to form a modified polymer composition, wherein the pigment, the filler, or a combination thereof have a second propensity to agglomerate in the modified polymer composition, and wherein the second propensity to agglomerate is less than the first propensity to agglomerate.

In a still further aspect, methods of purging a polymer composition are provided. In some embodiments, the methods include providing a polymer composition comprising a pigment, a filler, or a combination thereof; and contacting the polymer composition with a purging agent to form a modified polymer composition, wherein the purging agent comprises a 1-butene polymer; wherein the purging agent reduces or minimizes scrap, downtime, or a combination thereof of the modified polymer composition relative to the polymer composition. The polymer composition may comprise polypropylene at an amount of at least 50% by weight of the polymer composition. The 1-butene polymer may have a melt flow rate of about 0.1 to about 3000 g/10 min at a temperature of 190′C, a load of 2.16 kg; and a density of about 0.915 g/cm³.

In another aspect, methods of promoting migration of an additive of a polymer composition are provided. The methods may include providing a polymer composition comprising one or more additives; and contacting the polymer composition with a migration promoter to form a modified polymer composition, wherein the migration promoter comprises a 1-butene polymer; wherein the migration promoter maximizes or increases the amount of the one or more additives at or adjacent to the surface of the modified polymer composition relative to the polymer composition.

Additionally, the present disclosure further describes articles that may be used in food packaging, films, tubing, caps and closures, gaskets, hot water heater liners, hot melt adhesives, compounding and masterbatches, fibers, sealants, BOPP film, purging compounds and piping systems. In some embodiments, the articles include a composition, wherein the composition includes a 1-butene polymer; a pigment; a polypropylene; and optionally one or more additives; wherein the 1-butene polymer is present in the composition at an amount of about 5% to about 20% by weight, based on the weight of the composition; wherein the pigment is present in the composition at an amount of about 10% to about 45% by weight, based on the weight of the composition; wherein the polypropylene is present in the composition at an amount of about 25% to about 85% by weight, based on the weight of the composition; wherein the pigment is in a particulate form having an average particle size of about 5 μm to about 55 μm; and wherein the one or more additives are present in the composition at an amount of about 0% to about 10% by weight, based on the weight of the composition.

While multiple embodiments are disclosed, still other embodiments will become apparent to those skilled in the art from the following detailed description. As will be apparent, certain embodiments, as disclosed herein, are capable of modifications in various aspects, all without departing from the spirit and scope of the claims as presented herein. Accordingly, the drawings and detailed description are to be regarded as illustrative in nature and not restrictive.

### BRIEF DESCRIPTION OF THE DRAWINGS

The figures provided herein and outlined below are intended to demonstrate certain, non-limiting embodiments and technical features associated with aspects of the present disclosure.

FIG. 1 shows an evaluation of pigment dispersion for an embodiment of a masterbatch composition of the present disclosure.

FIG. 2 shows a comparison of various embodiments of carrier resins as a function of delta L (ΔL), defined as the difference in lightness (black-white scale) of a measured composition.

FIG. 3 shows a stress at break profile as a function of MFR for an embodiment of a PB-1 comprising polymer.

### DETAILED DESCRIPTION OF THE INVENTION

Provided herein are polybutene-1 compositions, including masterbatches and concentrates. The polybutene-1 compositions may be useful in many markets and applications including without limitation: food packaging (such as peelable sealants for easy open packaging), industrial film, tubing, caps and closures, gaskets, TPV & TPE, extrusion blow molding, hot water heater liners, hot melt adhesives, compounding and masterbatches, fibers, low seal initiation temperature sealants, BOPP film, purging compounds, piping systems (plumbing and underfloor heating).

In some embodiments, the compositions provided herein include a 1-butene polymer; a pigment; and a polypropylene. The 1-butene polymer may be present in the composition at an amount of about 0.1% to about 40% by weight, or about 5% to about 20% by weight, based on the weight of the composition. The pigment may be present in the composition at an amount of about 10% to about 45% by weight, based on the weight of the composition. The polypropylene may be present in the composition at an amount of about 25% to about 85% by weight, based on the weight of the composition.

The pigment may be in a particulate form. That is, the pigment may be in the form of particles. The particles may include granules, fibers, flakes, spheres, powders, platelets, other shapes and forms known to persons skilled in the art, or a combination thereof. The particles may be regularly shaped (e.g., substantially spherical), irregularly shaped, or a combination thereof. The particles may have an average particle size of about 5 μm to about 55 μm, about 5 μm to about 30 μm, about 5 μm to about 35 μm, about 5 μm to about 40 μm, about 5 μm to about 50 μm, about 10 μm to about 55 μm, about 10 μm to about 50 μm, about 10 μm to about 40 μm, about 10 μm to about 30 μm, or about 10 μm to about 20 μm .

The compositions may also include one or more additives. The one or more additives, when present in the compositions, may be present in the composition at an amount of about 0.01% to about 10% by weight, based on the weight of the composition. As explained herein, the one or more additives may be selected from a stabilizer, a nucleating agent, a slip agent, an antiblocking agent, a lubricant, an antistatic agent, a modifier of molecular weight, a modifier of one or more rheological properties, or a combination thereof.

One or more of the 1-butene polymers provided herein may be used to modify the viscosity of a polymer composition. The polymer composition may include polypropylene. Methods are provided for modifying the viscosity of a polymer composition. In some embodiments, the methods include providing a polymer composition comprising polypropylene, wherein the polymer composition has a first viscosity; contacting the polymer composition with a 1-butene polymer to form a modified polymer composition having a second viscosity; wherein the first viscosity and the second viscosity are different. In some embodiments, the first viscosity is greater than the second viscosity. In some embodiments, the second viscosity is greater than the first viscosity.

Generally, the methods provided herein a polymer composition and a 1-butene polymer may be contacted in any manner, using any technique known in the art. In some embodiments, the 1-butene is substantially uniformly dispersed in the polymer composition after the contacting. In some embodiments, the 1-butene is not uniformly dispersed in the polymer composition after the contacting. The contacting of a polymer composition with a 1-butene polymer may include combining and extruding the polymer composition and the 1-butene polymer. The extrusion of the polymer composition and the 1-butene may be performed at a pressure less than a pressure used to extrude a comparative composition including only the polymer composition.

One or more of the 1-butene polymers provided herein may be used as an impact modifier. The impact modifier may modify the durability of a polymer composition. The polymer composition may include polypropylene. Methods are provided for modifying the durability of a polymer composition. In some embodiments, the methods include providing a polymer composition comprising polypropylene, wherein the polymer composition has a first durability; contacting the polymer composition with a 1-butene polymer to form a modified polymer composition having a second durability; wherein the first durability and the second durability are different. In some embodiments, the first durability is greater than the second durability. In some embodiments, the second durability is greater than the first durability. A 1-butene polymer may act as a viscosity modifier and an impact modifier.

One or more of the 1-butene polymers provided herein may be used as a flexibilizer. The flexibilizer may modify the flexibility of a polymer composition. The polymer composition may include polypropylene. Methods are provided for modifying the flexibility of a polymer composition. In some embodiments, the methods include providing a polymer composition comprising polypropylene, wherein the polymer composition has a first flexibility; contacting the polymer composition with a 1-butene polymer to form a modified polymer composition having a second flexibility; wherein the first flexibility and the second flexibility are different. In some embodiments, the first flexibility is greater than the second flexibility. In some embodiments, the second flexibility is greater than the first flexibility. A 1-butene polymer may act as a viscosity modifier, an impact modifier, a flexibilizer, or any combination thereof.

One or more of the 1-butene polymers provided herein may be used as a dispersion aid, such as a non-blooming dispersion aid. The dispersion aid may promote or facilitate the dispersion of a pigment, a filler, or a combination thereof in a polymer composition. Methods are provided for dispersing a pigment and/or filler in a polymer composition. In some embodiments, the methods include , the method providing a polymer composition comprising a pigment, a filler, or a combination thereof; and contacting the polymer composition with a non-blooming dispersion aid to form a modified polymer composition, wherein the non-blooming dispersion aid comprises a 1-butene polymer; wherein the polymer composition has one or more surface characteristics that are substantially identical to one or more surface characteristics of the modified polymer composition. A 1-butene polymer may act as a viscosity modifier, an impact modifier, a flexibilizer, a dispersion aid, or any combination thereof.

One or more of the 1-butene polymers provided herein may be used to prevent re-agglomeration, or reduce the likelihood of re-agglomeration, of one or more components in a polymer composition. The one or more components may include a pigment, a filler, or a combination thereof. Methods are provided that may include providing a polymer composition comprising a pigment, a filler, or a combination thereof, wherein the pigment, the filler, or a combination thereof have a first propensity to agglomerate; and contacting the polymer composition with a 1-butene polymer to form a modified polymer composition, wherein the pigment, the filler, or a combination thereof have a second propensity to agglomerate in the modified polymer composition, wherein the second propensity to agglomerate is less than the first propensity to agglomerate. The second propensity to agglomerate may be about 10% to 100% less than the first propensity to agglomerate.

One or more of the 1-butene polymers herein may be used as a purging agent. The purging agent may reduce or minimize scrap, downtime, or a combination thereof. Methods of purging a polymer composition are provided. The methods may include providing a polymer composition comprising a pigment, a filler, or a combination thereof; and contacting the polymer composition with a purging agent to form a modified polymer composition, wherein the purging agent comprises a 1-butene polymer; wherein the purging agent reduces or minimizes scrap, downtime, or a combination thereof of the modified polymer composition relative to the polymer composition.

One or more of the 1-butene polymers herein may be used as migration promoter. The migration promoter may facilitate the migration of one or more additives, such as a fluorochemical surface-modifying additive or nanoclay, to the surface of a polymer composition. Methods of promoting migration of an additive of a polymer composition are provided. The methods may include providing a polymer composition comprising one or more additives; and contacting the polymer composition with a migration promoter to form a modified polymer composition, wherein the migration promoter comprises a 1-butene polymer; wherein the migration promoter maximizes or increases the amount of the one or more additives at or adjacent to the surface of the modified polymer composition relative to the polymer composition.

In any of the methods described herein, a polymer composition may include polypropylene, and the polypropylene may be present in the polymer composition at an amount of at least 50% by weight, based on the weight of the polymer composition.

### 1-Butene Polymers (Polybutene-1 Polymers) (PB-1)

Polybutene-1 polymers that may be suitable for use in the present disclosure include linear homopolymers that are semicrystalline and highly isotactic (having in particular an isotacticity from 96 to 99%, measured both as mmmm pentads/total pentads using NMR and as quantity by weight of matter soluble in xylene at 0° C.).

In some embodiments, the 1-butene polymer of the compositions herein has a melt flow rate of about 0.1 to about 3000 g/10 min, about 200 to about 1500 g/10 min, about 400 to about 1500 g/10 min, about 500 to about 1300 g/10 min, about 2000 to about 3000 g/10 min, about 2200 to about 3000 g/10 min, or about 2400 to about 3000 g/10 min at a temperature of 190° C.; a load of 2.16 kg; and a density of about 0.915 g/cm³.

The polybutene-1 polymers may be obtained by polymerization of butene-1 with a stereospecific catalyst, and a binary mixture with polypropylene. In the case when a copolymer of butene-1 is used, the isotacticity index can be expressed as matter that is insoluble in xylene, still at 0° C., and may be greater than or equal to 60%. Alternatively the polybutene-1 used in the carriers of the present disclosure may have a melting point of crystalline form 2 (the first to form, being favored kinetically) from 81 to 109° C. Such suitable polymers are disclosed in WIPO Pat. App. Pub. No. WO2005/014714, the contents of which are hereby incorporated by reference in full.

Further suitable polymers of butene-1 are both the homopolymers and the copolymers comprising up to 30 mol. % of olefinic comonomers (such as polymers comprising ethylene and alpha-olefins containing from 5 to 8 carbon atoms). These polymers can be obtained, for example, by low-pressure Ziegler-Natta polymerization of butene-1, for example by polymerizing butene-1 (and any comonomers) with catalysts based on TiCl₃, or halogenated compounds of titanium supported on magnesium chloride, and suitable co-catalysts (in particular alkyl compounds of aluminum). High values of melt flow rate may be obtained by successive treatment of the polymer with peroxides. Polymers of butene-1 used in embodiments of carriers of the present disclosure may be solid polymers at room temperature.

Ziegler-Natta catalyzed PB0800 polybutene-1 and PB0801 (sold by LyondellBasell Industries) may be particularly suitable for use in embodiments of the present disclosure. PB0800 polybutene-1 is a homopolymer having a melt flow rate of 200 g/10 min at a temperature of 190° C. and a load of 2.16 kg.

Physical properties associated with PB0800 polybutene-1 are presented in the following table:

| PHYSICOCHEMICAL | ASTM | | |
|---|---|---|---|
| PROPERTIES | METHOD | VALUE | |
| Melt flow rate | D1238 | 200 g/10 min | |
| Density | D1505 | 0.915 | cm³ |
| Tensile stress at yield | D638 | 13.8 | MPa |
| Tensile stress at break | D638 | 29.0 | MPa |
| Elongation at break | D638 | 350% | |
| Elastic modulus | D638 | 241 | MPa |
| Shore hardness | D2240 | 55 | |
| Embrittlement temperature | D746 | −18° | C. |
| Melting range | DSC | 124-126° | C. |
| Vicat softening point | D1525 | 116° | C. |
| Thermal conductivity | C177 | 0.00043 | cal/s/cm/K |

The typical physical properties of PB0801 polybutene-1 are presented in the following table:

| PHYSICOCHEMICAL | ASTM | | |
|---|---|---|---|
| PROPERTIES | METHOD | VALUE | |
| Melt flow rate | ISO 1133-1 | 200 | g/10 min |
| Density | ISO 1183-1 | 0.915 | cm³ |
| Flexural Modulus | ISO 178 | 410 | MPa |
| Tensile stress at break | ISO 8986-2 | 30.0 | MPa |
| Elongation at break | ISO 8986-2 | 300% | |
| Melting Temperature Tm1 | ISO 11357-3 | 126° | C. |
| Melting Temperature Tm2 | ISO 11357-3 | 113° | C. |

The mechanical properties of PB0801 were measured on specimens conditions for 10 days at 23° C. The Tm2 of PB0801 corresponds with the melting point of crystalline form 2 measured immediately after solidification.

Additional PB-1 materials within the scope of this disclosure include at least the following grades available from LyondellBasell:

| | | | | Flexural | | | |
|---|---|---|---|---|---|---|---|
| Product | | C2 | Tm1 | Modulus | Density | Typical customer | |
| type | MFR* | w % | (° C.) | (MPa) | (g/cm³) | applications | Type |
| PB | 0.4 | — | 128 | 450 | 0.915 | Easy-open, | Homopolymer |
| 0110M | | | | | | retortable | |
| PB | 4.0 | — | 128 | 450 | 0.915 | Easy-open, | Homopolymer |
| 0300M | | | | | | retortable, | |
| | | | | | | Compounding, MB | |
| PB | 200 | — | 124 | 400 | 0.915 | Compounding, | Homopolymer |
| 0801M | | | | | | HMA, MB, Fibre, | |
| | | | | | | Rheo. mod. | |
| PB | 0.9 | Low | 114 | 250 | 0.906 | Easy-open | Random |
| 8640M | | | | | | packaging | copolymer |
| PB | 4.0 | Low | 114 | 270 | 0.906 | Easy-open | Random |
| 8340M | | | | | | packaging | copolymer |
| DP | 3.0 | Med | 97 | 120 | 0.901 | Sealant resin for PP | Random |
| 8220M | | | | | | | copolymer |
| DP | 3.0 | High | 94 | 100 | 0.897 | Specialty film | Random |
| 8310M | | | | | | | copolymer |
| DP | 45 | High | 93 | 65 | 0.895 | HMA, Rheology | Random |
| 8510M | | | | | | modification | copolymer |
| DP | 200 | High | 90 | 60 | 0.895 | HMA, Fibre and | Random |
| 8911ME | | | | | | Rheology | copolymer |
| | | | | | | modification | |

MFR* measured at 190° C. and using a 2.16 kg weight

### Metallocene Catalyzed Polybutene-1

Metallocene catalyzed polybutene-1 (such as PB1200M, and PBM0700M sold by LyondellBasell Industries) may be used in certain embodiments of the present disclosure. Such polymers are disclosed in WIPO Pat. App. Pub. No. WO2006/045687, the contents of which are hereby incorporated by reference in full. In various embodiments PB1200M may be a random copolymer having an MFR of 1200 g/10 min (190° C. and using a 2.16 kg weight); a Tₘ₁ of 102° C.; and a flexural modulus of 339 MPa. In various embodiments PB700M may be a random copolymer having an MFR of 750 g/10 min (190° C. and using a 2.16 kg weight); a Tₘ₁ of 88° C.; and a flexural modulus of 88 MPa.

In some embodiments, the present disclosure includes 1-butene polymer optionally containing from 0 to 30% by mol of derived units of ethylene, propylene or alpha-olefin of formula CH₂=CHZ, wherein Z is a C₃-C₂₀ linear or branched alkyl radical, having the following features:
a) a distribution of molecular weight (Mw/Mn) lower than 4; alternatively lower than 3; alternatively lower than 2:5;
b) a melt flow rate (MFR) measured according to ISO 1133 (190° C., 2.16 kg) ranging from 0.1 to 3000 g/10 min; alternatively from 200 to 1500 g/10 min; alternatively from 200 to 1500; alternatively from 300 and 900; alternatively between 400 and 900;
c) an intrinsic viscosity (IV) measured in tetrahydronaphthalene (THN) at 135° C. lower than 0.8 dl/g; alternatively the intrinsic viscosity is comprised between 0.2 dl/g and 0.6 dl/g; alternatively IV is comprised between 0.3 dl/g and 0.6 dl/g; alternatively between 0.3 dl/g and 0.5 dl/g;
d) optionally the melting point may be higher than 90° C.; alternatively higher than 100° C.; alternatively higher than 102° C.; however, in various embodiments the melting point may be lower than 90° C.;
e) isotactic pentads (mmmm) measured with ¹³C-NMR operating at 100.61 MHz may be higher than 90%; alternatively higher than 95%;
f) 4,1 insertions may not detectable at a ¹³C-NMR operating at 100.61 MHz;
g) yellowness index may be lower than 0; alternatively comprised between 0 and −10; alternatively comprised between −1 and −5; alternatively comprised between −2 and −4; and
h) an aluminum content may range from 2 ppm by weight to 40 ppm by weight.

The 1-butene polymers of the present disclosure may be a 1-butene homopolymer or a 1-butene/ethylene copolymer or a 1-butene/propylene copolymer.

In various embodiments of the 1-butene polymer of the present disclosure the aluminum content that constitutes the greater part of the catalyst residues may range from 2 ppm by weight to 40 ppm by weight; alternatively the aluminum content ranges from 2 ppm by weight to 30 ppm by weight; alternatively from 3 ppm by weight to 20 ppm by weight

The 1-butene polymer of the present disclosure can be obtained with a process that uses a particular class of metallocene-based catalyst systems. In embodiments of a process for preparing 1-butene polymers having the features described above, the process may include polymerizing 1-butene or copolymerizing 1-butene with ethylene, propylene or an alpha-olefin of formula CH₂=CHZ wherein Z is a C₃-C₁₀ alkyl group, in the presence of a hydrogen concentration in the reactor higher than 1000 mol ppm and in the presence of a catalyst system obtainable by contacting:
(A) a metallocene compound belonging to the following formula (I):

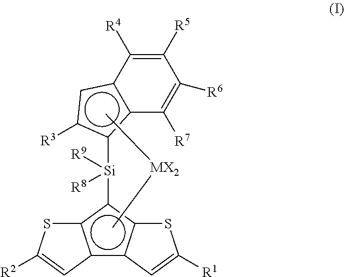

wherein:

M is an atom of a transition metal selected from those belonging to group 3,4, or to the lanthanide or actinide groups in the Periodic Table of the Elements; for instance M is zirconium;

X, equal to or different from each other, is a hydrogen atom, a halogen atom, a R, OR, OR′O, OSO₂CF₃, OCOR, SR, NR₂ or PR₂ group wherein R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; optionally containing heteroatoms belonging to groups 13-17 of the Periodic Table of the Elements; and R′ is a C₁C₂₀-alkylidene, C₆-C₂₀-arylidene, C₇-C₂₀-alkylarylidene, or C₇-C₂₀-arylalkylidene radical; in some embodiments X is a hydrogen atom, a halogen atom, a OR′O or R group; for instance X may be a chloride or a methyl radical;

R¹, R², R⁵, R⁶, R⁷, R⁸ and R⁹, equal to or different from each other, are hydrogen atoms, or C₁-C₄₀ hydrocarbon radicals optionally containing heteroatoms belonging to groups 13-17 of the Periodic Table of the Elements; in certain embodiments R¹, R², R⁵, R⁶, R⁷, R⁸ and R⁹, equal to or different from each other, are hydrogen atoms or linear or branched, cyclic or acyclic, C₁-C₂-C₄₀ alkenyl, C₂-C₄₀ alkynyl, C₆-C₄₀-aryl, C₇-C₄₀-alkylaryl or C₇-C₄₀-arylalkyl radicals, optionally containing heteroatoms belonging to Groups 13-17 of the Periodic Table of the Elements; or R⁵ and R⁶, and/or R⁸ and R⁹ can optionally form a saturated or unsaturated, 5 or 6 membered rings, said ring can bear C₁-C₂₀ alkyl radicals as substituents; with the proviso that at least one of R⁶ or R⁷ is a linear or branched, cyclic or acyclic, C₁-C₄₀-alkyl, C₂-C₄₀ alkenyl, C₂-C₄₀ alkynyl radical, optionally containing heteroatoms belonging to Groups 13-17 of the Periodic Table of the Elements; for instance a C₁-C₁₀-alkyl radical; and in some embodiments R¹ and R² are the same and are C₁-C₁₀ alkyl radicals optionally containing one or more silicon atoms; for example R¹ and R² may be methyl radicals;

R⁸ and R⁹, equal to or different from each other, may in some embodiments comprise C₁-C₄₀ alkyl or C₆-C₂₀ aryl radicals; for instance they may comprise methyl radicals;

R⁵ may be selected from a hydrogen atom or a methyl radical;

R⁶ may be selected from a hydrogen atom or a methyl, ethyl or isopropyl radical;

R⁷ may be selected from a linear or branched, cyclic or acyclic, C₁-C₄₀-alkyl, C₂-C₄₀alkenyl, C₂-C₄₀ alkynyl radical, optionally containing heteroatoms belonging to Groups 13-17 of the Periodic Table of the Elements; including a C₁-C₁₀-alkyl radical such as a methyl or ethyl radical; alternatively when R⁶ is different from a hydrogen atom, R⁷ may be a hydrogen atom;

R³ and R⁴ equal to or different from each other, are linear or branched, cyclic or acyclic, C₁-C₄₀ alkenyl, C₂-C₄₀ alkynyl radicals, optionally containing heteroatoms belonging to Groups 13-17 of the Periodic Table of the Elements; for instance R³ and R⁴ equal to or different from each other may comprise C₁C₁₀-alkyl radicals; in some embodiments R³ is a methyl, or ethyl radical; and R⁴ is a methyl, ethyl or isopropyl radical;
(B) an alumoxane or a compound capable of forming an alkyl metallocene cation; and optionally
(C) an organo aluminum compound.
Metallocene compounds of formula (I) have been described, for example, in WIPO Pat. App. Pub. No. WO 01/47939 or in EP Pat. App. No. 04101020.8.

In some embodiments, the compounds of formula (I) may comprise formula (Ia) or (Ib):

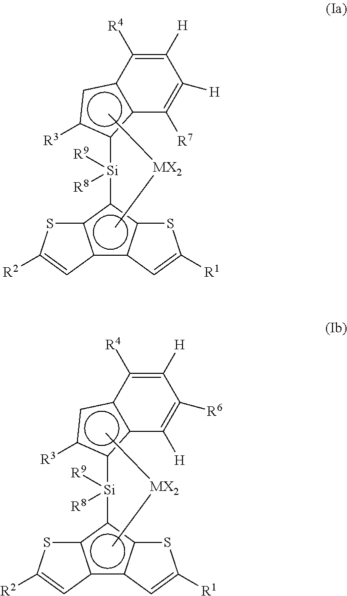

wherein M, X, R¹, R², R⁸ and R⁹ comprise chemical groups as described above; R³ and R⁴, equal to or different from each other, are linear or branched, cyclic or acyclic, C₁-C₄₀-akyl, C₂-C₄₀ alkenyl, C₂-C₄₀ alkynyl radicals, optionally containing heteroatoms belonging to Groups 13-17 of the Periodic Table of the Elements; for instance R³ and R⁴ equal to or different from each other may comprise C₁-C₁₀-alkyl radicals; in certain embodiments R³ is a methyl, or ethyl radical; and R⁴ is a methyl, ethyl or isopropyl radical; R⁶ and R⁷R³ and R⁴, equal to or different from each other, are linear or branched, cyclic or acyclic, C₁-C₄₀-alkyl, C₂-C₄₀ alkenyl, C₂-C₄₀ alkynyl radicals optionally containing heteroatoms belonging to Groups 13-17 of the Periodic Table of the Elements; including C₁-C₁₀-alkyl radicals; for example R⁷ may comprise a methyl or ethyl radical; and R⁶ may comprise a methyl, ethyl or isopropyl radical.

Alumoxanes used as component B) can be obtained by reacting water with an organoaluminum compound of formula HⱼAlU₃₋ⱼ or HⱼAl₂U₆₋ⱼ, where U substituents, same or different, are hydrogen atoms, halogen atoms, C₁C₂₀-alkyl, C₃-C₂₀-cyclalkyl, C₆-C₂₀-aryl, C₇-C₂₀-alkylaryl or or C7-C20-arylalkyl radical, optionally containing silicon or germanium atoms with the proviso that at least one U is different from halogen, and j ranges from 0 to 1, being also a non-integer number. In this reaction the molar ratio of Al/water may be between 1:1 and 100:1. In some embodiments, the molar ratio between aluminum and the metal of the metallocene generally may be between about 10:1 and about 20000:1, such as about 100:1 and about 5000:1. The alumoxanes used in the catalyst according to the present disclosure are considered to be linear, branched or cyclic compounds containing at least one group of the type:

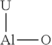

wherein the substituents U, same or different, are described above. In some embodiments, alumoxanes of the general formula:

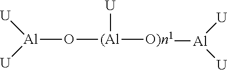

can be used in the case of linear compounds, wherein n¹ is 0 or an integer from 1 to 40 and the substituents U are defined as above, or alumoxanes of the formula:

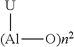

can be used in the case of cyclic compounds, wherein n² is an integer from 2 to 40 and the U substituents are defined as above. Examples of alumoxanes for use in the present technology include methylalumoxane (MAO), tetra-(isobutyl)alumoxane (TIBAO), tetra-(2,4,4-trimethylpentyl)alumoxane (TIOAO), tetra-(2,3-dimethylbutyl)alumoxane (TDMBAO) and tetra-(2,3,3-trimethylbutyl)alumoxane (TTMBAO). Additionally, cocatalysts such as those described in WIPO Pat. App. Pub. Nos. WO 99/21899 and WO 01/21674 may be used, in which the alkyl and aryl groups have specific branching patterns. Non-limiting examples of aluminum compounds according to WO 99/21899 and WO01/21674 include: tris(2,3,3-trimethyl-butyl)aluminum, tris(2,3-dimethyl-hexyl)aluminum, tris(2,3-dimethyl-butyl)aluminum, tris(2,3-dimethylpentyl)aluminum, tris(2,3-dimethyl-heptyl)aluminum, tris(2-methyl-3-ethyl-pentyl)aluminum, tris(2-methyl-3-ethyl-hexyl)aluminum, tris(2-methyl-3-ethyl-heptyl)aluminiun, tris(2-methyl-3-propyl -hexyl)aluminum, tris(2-ethyl-3-methyl-butyl)aluminum, tris(2-ethyl-3-methyl-pentyl)aluminum, tris(2,3-diethyl-pentyl)aluminum, tris(2-propyl-3-methyl-butyl)aluminum, tris(2-isopropyl -3-methyl-butyl)aluminum, tris(2-isobutyl -3-methyl-pentyl)aluminum, tris(2,3,3-trimethyl -pentyl)aluminum, tris(2,3,3-trimethyl-bexyl)aluminum, tris(2-ethyl-3,3-dimethyl-butyl)aluminum, tris(2-ethyl-3,3-dimethylpentyl)aluminum, tris(2-isopropyl-3,3-dimethyl-butyl)aluminum, tris(2-trimethyl silyl-propyl)aluminum, tris(2-methyl-3-phenyl-butyl)aluminum, tris(2-ethyl-3-phenylbutyl)aluminum, tris(2,3-dimethyl-3-phenyl -butyl)aluminum, tris(2-phenylpropyl)aluminum, tris[2-(4-fluoro-phenyl)-propyl]aluminum, tris[2-(4-chloro-phenyl)-propyl]aluminum, tris[2-(3-isopropyl-phenyl)-propyl]aluminum, tris(2-phenylbutyl)aluminum, tris(3-methyl-2-phenyl-butyl)aluminum, tris(2-phenylpentyl)aluminum, tris[2-(pentafluorophenyl) -propyl]aluminum, tris[2,2-diphenyl ethyl]aluminum and tris[2-phenyl-2-methyl -propyl]aluminum, as well as the corresponding compounds where one of the hydrocarbyl groups is replaced with a hydrogen atom, and those wherein one or two of the hydrocarbyl groups are replaced with an isobutyl group.

Non-limiting examples of compounds able to form an alkylmetallocene cation are compounds of the general formula D⁺E−, wherein D⁺ is a Brønsted acid, able to donate a proton and to react irreversibly with a substituent X of the metallocene of formula (I), and E is a compatible anion, which is able to stabilize the active catalytic species originating from the reaction of the two compounds, and which is sufficiently labile to be able to be removed by an olefinic monomer. In some embodiments, the anion E⁻ comprises one or more boron atoms. In additional embodiments, the anion E⁻ is an anion of the formula BAr₄⁽⁻⁾, wherein the substituents Ar which can be identical or different are aryl radicals such as phenyl, pentafluorophenyl or bis(trifluoromethyl)phenyl. In further embodiments, tetrakis-pentafluorophenyl borate compounds such as those described in WIPO Pat. App. Pub. No. WO 91/02012 may be used. Moreover, compounds of the general formula BAr₃ can be used. Compounds of this type are described, for example, in the WIPO Pat. App. Pub. No. WO 92/00333. Other examples of compounds able to form an alkylmetallocene cation are compounds of the general formula BAr₃P, wherein P is a substituted or unsubstituted pyrrol radical. These compounds are described in WIPO Pat. App. Pub. No. WO01/62764. Other examples of cocatalyst can be found in EP 775707 and DE 19917985. Compounds containing boron atoms can be conveniently supported according to the descriptions of DE Pat. App. Nos. DE-A-19962814 and DE-A-19962910. All of the above referenced compounds containing boron atoms can be used in a molar ratio of boron and the metal of the metallocene of about 1:1 to about 10:1; including about 1:1 to about 2.1 and about 1:1.

Non-limiting examples of compounds of formula D⁺E⁻ are: tributylammoniumtetra(pentafluorophenyl)borate, tributylammoniumtetra(pentafluorophenyl)aluminate, tributylammoniumtetra(trifluoromethylphenyl)borate, tributylammoniumtetra(4-fluorophenyl)borate, N,N-dimethylaniliniumtetrakis(pentafluorophenyl)boratee, N,N-dimethylaniliniumtetrakis(pentafluorophenyl)aluminate, di(propyl)ammoniumtetrakis(pentafluorophenyl)borate, di(cyclohexyl)ammoniumtetrakis(pentafluorophenyl)borate, triphenylcarbeniumtetrakis(pentafluorophenyl)borate, triphenylcarbeniumtetrakis(pentafluorophenyl)aluminate, ferroceniumtetrakis(pentafluorophenyl)borate, ferroceniumtetrakis(pentafluorophenyl)aluminate, triphenylcarbeniumtetrakis(pentafluorophenyl)borate and N,N-dimethylaniliniumtetrakis(pentafluorophenyl)borate.

Additional examples of compounds of the general formula D⁺E⁻ that can be used according to the present disclosure are described in WIPO Pat. App. Pub. Nos. WO 04/005360, WO 02/102811 and WO 01/62764. Organic aluminum compounds for use as compound C) are those of the general formula HⱼAlU₃₋ⱼ or HⱼAl₂U₆₋ⱼ described above.

The polymerization process of the present disclosure may be carried out in liquid phase, optionally in the presence of an inert hydrocarbon solvent, or in gas phase. The hydrocarbon solvent can be either aromatic (such as toluene) or aliphatic (such as propane, hexane, heptane, isobutane, cyclohexane and 2,2,4-trimethylpentane, isododecane). In certain embodiments, the polymerization process of the present disclosure is carried out by using liquid 1-butene as polymerization medium. In some embodiments, the polymerization temperature ranges from about 20° C. to about 150° C., such as between 50° C. and 90° C. The 1-butene polymer object of the present disclosure is endowed with a very low aluminum content that is the bigger part of the catalyst residue. This is due to the fact that the activity of the metallocene compound of formula (I) in the presence of high amount of hydrogen is strongly increased, therefore hydrogen can be advantageously used both as molecular weight regulator and as activator of the catalyst system. This synergistic effect allows for production of the 1-butene polymer object of the present disclosure at very high yields, and consequently lowering the content of catalyst residue.

This advantage may render the polymer object of the present disclosure fit for food packaging and medical uses.

The concentration of hydrogen during the polymerization reaction may be higher than 1000 mol ppm; alternatively it is higher than 2000 mol ppm and lower than 10000 mol ppm; alternatively it is comprised between 3000 mol ppm and 8000 mol ppm.

The propylene polymers that can be used in the concentrates of the present disclosure can be isotactic crystalline homopolymers or copolymers of propylene, without distinction. Among the copolymers, the isotactic crystalline copolymers of propylene with ethylene and/or CH₂=CHR alpha-olefins in which R is an alkyl radical with 2-8 carbon atoms (for example butene-1, hexene-1, octene-1), containing more than 85 wt. % of propylene, are particularly suitable. The isotacticity index of the disclosed propylene polymers is, in some embodiments, greater than or equal to 90, measured as the fraction that is insoluble in boiling heptane or in xylene at room temperature (approximately 25° C.).

### Definitions

The terms “additives”, “pigments” and “fillers” are commonly employed in this field for indicating the substances that are added to polymers during processing.

The term “pigments” includes organic and inorganic substances, including, but not limited to, carbon black, titanium dioxide (TiO₂), chromium oxides, phthalocyanines, or a combination thereof.

The term “fillers” includes, but is not limited to, substances such as talc, carbonates, micas, or a combination thereof.

Both pigments and the fillers are specific examples included within the general definition of additives.

Apart from pigments and fillers, the term “additives” also generally includes the categories of substances listed below.
1) Stabilizers.

Examples of stabilizers are:
A) antiacids, for example stearates, carbonates and synthetic hydrotalcite;
B) light stabilizers, for example UV absorbers, such as benzophenones, benzotriazoles, carbon black; “quenchers”, including but not limited to organic complexes of nickel; and HALS (Hindered Amine Light Stabilizers);
C) antioxidants, for example phenols, phosphites, phosphonites and compounds that are synergistic with respect to the antioxidants, for example thioesters and thioethers.
2) Process Coadjuvants and Modifiers.

Examples of such additives include:
D) nucleating agents, for example dibenzylidenesorbitol, organic carboxylic acids and their salts, such as adipic acid, benzoic acid, sodium benzoate and adipate;
E) slip agents, for example erucamide and oleamide;
F) antiblocking agents, for example silicon dioxide (SiO₂), synthetic zeolites;
G) lubricants and antistatic agents, for example glycerylmonostearate, waxes and paraffin oils, ethoxylated amines; and
H) modifiers of molecular weight and rheological properties, for example peroxides.

In some embodiments, the concentrates of the present disclosure allow for the dispersion of solid substances in polyolefins. Accordingly, concentrates in which the additives are solids at room temperature may be used.

In certain embodiments, the additives are in the concentrates of the present disclosure in amounts from 5 to 60 wt. %, including from 5 to 50 wt. %, and from 20 to 40 wt. %, relative to the total weight of the concentrate. Accordingly, concentrates may be obtained containing (percentages by weight):
A) from 40% to 95%, such as from 50% to 95% and from 60% to 80%, of a composition comprising, relative to the total weight of A): 1) from 10% to 35%, including from 25% to 35% and from 30% to 35%, of polybutene-1; 2) from 90% to 65%, such as from 75% to 65% and from 70% to 65%, of polypropylene; and B) from 5% to 60%, including from 5% to 50% and from 20% to 40% of one or more additives. The percentages of A) and B) refer to the total weight of the concentrate.

The concentrates of the present disclosure can be prepared by mixing the aforesaid components, employing processes and equipment that are well known in the field of processing of olefinic polymers. In some embodiments, two processes that may be used for the processing of polyolefin-based masterbatches include:
1) dry blend; and
2) extrusion.

The dry blend or dry blending process, which encompasses dry mixing, and optionally grinding, of the components in the blend, utilizes equipment such as:
a) mills (with cutters or with disks, with cryogenic plant or at room temperature);
b) screens; and
c) mixers (continuous or turbomixers).

The extrusion process may, in certain embodiments, consist of fluid-phase homogenization of the components of the blend. This process may optionally encompass a dry blend stage prior to the extrusion stage proper, depending on whether subsequent processing is performed on powders or granules. In some embodiments, the various stages and equipment of the process may include:
a) dry blending (if required);
b) feeding (using gravimetric or volumetric dispensers);
c) extrusion (using single-screw or twin-screw extruders; the latter can be co-rotating of the slow or fast type, or counter-rotating);
d) cooling (in water, or on cooled belts);
e) granulation (by a cutting unit, or with cutting in the extruder head); and
f) homogenization (in homogenizing silos) and packing.

The concentrates of the present disclosure can be blended with crystalline homopolymers and copolymers of propylene. In some embodiments, examples of olefinic polymers with which the concentrates of the present disclosure can be blended include:

crystalline homopolymers of propylene, including isotactic homopolymers, which in certain embodiments comprise an isotacticity index above 93%;

crystalline polymers of propylene with ethylene and/or C₄-C₁₀ alpha-olefins, in which the total content of comonomers (for example 1-butene, 1-hexene, 4-methyl-1-pentene and 1-octene) is between 0.05 and 20 wt. % relative to the weight of the copolymer;

polymers and copolymers of ethylene, such as LDPE, HDPE, LLDPE;

elastomeric copolymers of ethylene with propylene and/or C₄-C₁₀ alpha-olefins, possibly containing reduced quantities of a diene in a range of from 1 to 10 wt. %, such as 1,4-hexadiene, 1,5 -hexadiene and ethylidene-1-norbornene;

elastomeric thermoplastic compositions comprising a crystalline homopolymer or copolymer of propylene as described above, and an elastomeric portion containing an elastomeric copolymer of ethylene as described above, which may be prepared according to known methods, by mixing the components in the molten state or by sequential polymerization, and generally containing the above referenced elastomeric portion in quantities from 5 to 80 wt. %; and

homopolymers and copolymers of butene-1 as described above in connection with the carrier of the concentrates of the present disclosure, optionally blended with the elastomeric thermoplastic compositions described above.

Accordingly, a polyolefinic composition may be obtained containing the additives originally present in the concentrate, and ready for the processing required for obtaining the finished (manufactured) products.

The methods of blending can be the same as described previously for blending the components of the concentrates of the present disclosure.

### EXAMPLES

The following examples are included to demonstrate certain embodiments of the appended claims. Those of skill in the art should appreciate that many changes can be made in the specific embodiments which are disclosed and still obtain a like or similar result without departing from the spirit and scope of the disclosure herein.

All of the compositions, articles of manufacture, and methods disclosed and claimed herein can be made and executed without undue experimentation in light of the present disclosure. While the compositions, articles of manufacture, and methods of this disclosure have been described in terms of certain embodiments, it will be apparent to those of skill in the art that variations may be applied to the compositions, articles of manufacture, and methods, as well as in the steps or in the sequence of steps of the methods described herein without departing from the concept, spirit, and scope of the appended claims.

### Example 1

### Organic Pigment Dispersion in PP/PB0800

In a filter test with a laboratory fiber spinning line, an indirect evaluation of pigment dispersion was conducted. A masterbatch composition having 20% of pigment (cinquasia red (organic)) and 80% of a carrier (polypropylene (PP) homopolymer; MFR=15 dg/min) was tested with varying percentages of PB0800. The tests were performed with a blend of 70% masterbatch+30% LDPE (MFR=2 dg/min).

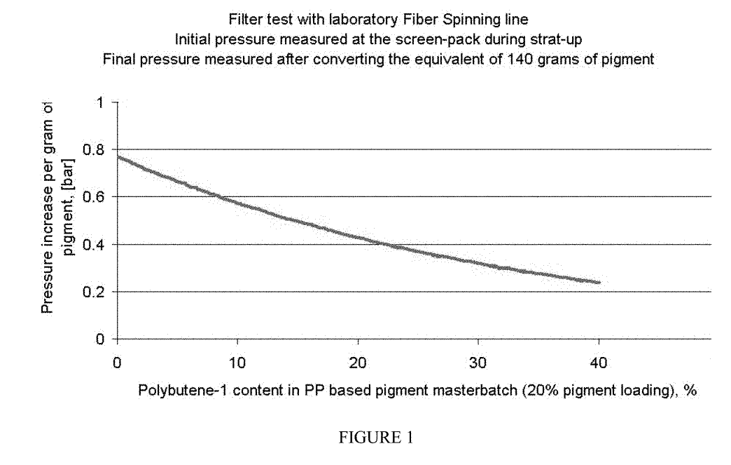

The initial pressure was measured at the screen-pack during start up, while the final pressure was measured after converting the equivalent of 140 grams of pigment. A pressure increase per gram of pigment (using a 20 micron mesh) was then calculated (see FIG. 1).

Micrographs were collected of a masterbatch with and without the PB-1 of the present disclosure. In the first sample of Example 1, a 17% green pigment, 10% PB M1200 and the balance PP was prepared; in the second sample of Example 1, a 17% green pigment plus the balance PP was prepared; in the third sample of Example 1, a 29% blue pigment, 10% PB M1200 and the balance PP was prepared; in the fourth sample of Example 1, a 29% blue pigment plus the balance PP was prepared. The results were as follows:

| | | Maximum |
|---|---|---|
| | Minimum Particle Size | Particle Size |
| Sample No. | (microns) | (microns) |
| 1 | 8 | 49.1 |
| 2 | 8.9 | 62.2 |
| 3 | 8.6 | 42.7 |
| 4 | 9.6 | 83.8 |

In various embodiments, pigmented compositions comprising 5-50 wt % (alternatively from 10-40 wt % and from 15-25) organic pigment; 5-25 wt % (alternatively from 5-15 wt % and from 8-12 wt %) PB-1 of the present disclosure; and the balance being polypropylene may be provided. Alternatively, the maximum particle size of the pigment dispersed within the pigmented composition may be less than 60 microns; alternatively less than 50 microns; and alternatively less than 45 microns.

### Example 2

### Titanium Dioxide (TiO2) Dispersion in PB0800 against PE and PP

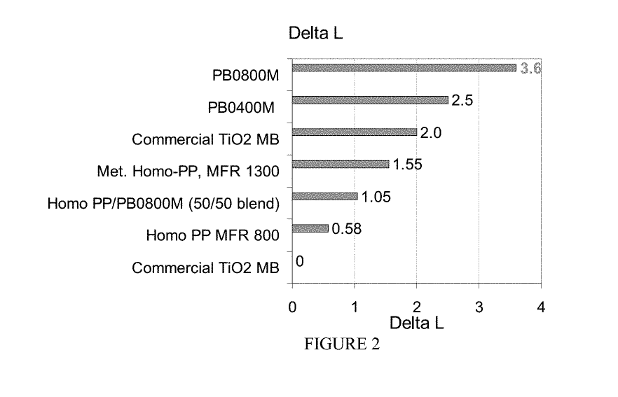

Titanium dioxide may be used as a white colorant and delivered in a masterbatch. In Example 2, 1.43% of a 70% titanium dioxide masterbatch in a basic homo-PP was prepared. Various carrier resins were prepared and compared as in FIG. 2. The PB0800 was the carrier resin that had the highest Delta L and therefore provides a suitable pigment dispersion, where delta L is the difference in lightness (black-white scale). Color strength and color position can be determined in terms of lightness (L), degree of red/green (a*) color and degree of blue/yellow color (b*) according to the CIE 1976 L*a*b* standard color space method, which is an international standard for color measurement known to the skilled artisan. The differences between the reference sample and a particular color sample are shown as an absolute difference in L, a* and b* and are written as Delta L, Delta a and Delta b, respectively. Delta e is the total relative error and is the deviation in color strength (lightness, L) and color position (red/green and blue/yellow offset) of the color values of a reference sample. Delta e can be calculated from Delta L, Delta a and Delta b according to the formula Δe=(ΔL+Δa+Δb)½.

### Example 3

### Organic Pigment Dispersion in PB0800 vs PE

Transmission light micrographs were collected for a LDPE film with a 5 wt % masterbatch, wherein the first masterbatch is a 26 wt % organic red and LDPE and the second masterbatch is a 26 wt % organic red and polybutene-1. The polybutene-1 masterbatch had a better pigment dispersion with respect to organic red as compared to the LDPE masterbatch in the film specimen. Transmission light micrographs were collected of a homo-polypropylene injection molded specimen with a 5 wt % masterbatch, wherein the first masterbatch is a 26 wt % organic red and LDPE composition and the second masterbatch is a 26 wt % organic red and polybutene-1 (PB-1) composition. The PB-1 masterbatch had a better pigment dispersion with respect to organic red as compared to the LDPE masterbatch in the injection molded specimen.

### Example 4

### Organic Pigment Dispersion in PB0800 vs PE &PP

Micrographs were collected of masterbatches based on different polymer carriers, each with 15 wt % of pigment red 122. 2 wt % of each of the respective masterbatches were blended with polypropylene, injection molded, and investigated by microscopy. A micrograph was collected for a 98 wt % of a masterbatch of 85 wt % PB0800 as the carrier with the balance being pigment red 122 blended with polypropylene. The dispersion quality was good and no pigment agglomerates were observed. A micrograph was collected for 98 wt % of a masterbatch of 85 wt % LDPE as the carrier, with the balance being pigment red 122 blended with polypropylene. The dispersion quality was fair and three pigment agglomerates were observed. Collected was micrograph of 98 wt % of a masterbatch of 65 wt % LDPE and 20 wt % PB0800 as the carrier, with the balance being pigment red 122 blended with polypropylene. The dispersion quality was fair and one pigment agglomerate was observed. Also collected was a micrograph of 98 wt % of a masterbatch of 65 wt % LDPE and 20 wt % PE wax as the carrier, with the balance being pigment red 122 blended with polypropylene. The dispersion quality was comparatively poor, with four pigment agglomerates observed. Collected was a micrograph of 98 wt % of a masterbatch of 85 wt % polypropylene as the carrier, with the balance being pigment red 122 blended with polypropylene. The dispersion quality was fair and three pigment agglomerates were observed. Applicants presently believe that pigment dispersion in PE and PP carriers are improved by the displacement of 10-50 wt % (alternatively 15-45 wt %, alternatively 20-30 wt %) of the respective PE or PP within the masterbatch with polybutene-1 (including for example PB0800).

### Example 5

### Carbon Black Dispersion in PB0800 versus PE

In Example 5, a first masterbatch of PE having 60 wt % carbon black was produced, and blended with 96 wt % polypropylene (Example 5, Sample 1). In Example 5, a second masterbatch of PB0800 having 60 wt % of carbon black (CB) was produced, and blended with 96% polypropylene (Example 5, Sample 1). The polypropylene used in Example 5, Sample 1 and Example 5, Sample 2 were the same. Polarized light optical microscopy (PLOM) micrographs indicated a color difference between PP film colored with the PB0800M based CB masterbatch and PP film colored with PE based CB masterbatch may be observed. In addition, the PLOM micrographs of PP film colored with PB0800M based CB masterbatch display finer, uniform pigment dispersion as compared the larger pigment agglomerates observed in PP colored with polyethylene (PE) based CB masterbatch, demonstrating that the pigment dispersion quality is improved when PB0800M is used as the CB masterbatch carrier.

### Example 6

### PB-1 as a Flow Modifier and Enhancer

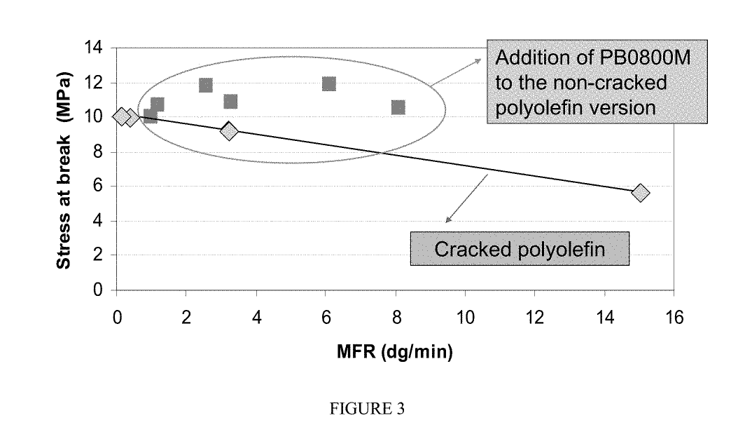

The addition of PB-1 was found to improve the flowability of low MFR polymers for advantageously avoiding, e.g. visbreaking (cracking) while beneficially maintaining the desired mechanical properties of the polymers. As shown in FIG. 3, the addition of PB0800M to a non-cracked low MFR polymer increases the stress at break profile as a function of MFR of the polymer. The increase is relative to a cracked polyolefin. The effects of PB0800M addition are enhanced with increasing MFR, which beneficially enhances the commercial value and utility of such polymers.

In Example 6 Experiment 1, the spiral lengths of a polypropylene reactor grade resin were observed before and after visbreaking the low MFR PP as follows:

| | Low MFR PP | |
|---|---|---|
| Property | (reactor grade) | Visbroken PP |
| MFR (2.16 kg/230 C.) dg/min | 0.49 | 15 |
| Spiral length at 60 bar, 200 C. (mm) | 60 | 143 |
| Spiral length at 100 bar, 200 C. (mm) | 120 | 205 |

In Example 6 Experiment 1, the same low MFR polyolefin reactor grade was blended in three respective amounts (to produce three different samples). The first blend included 5 weight percent PB1 (PB0800M), the second blend included 7.5 weight percent PB0800M, and the third blend included 10 weight percent PB-1 (PB0800M); and resulted in the following properties:

| | Low MFR PP | Low MFR PP | |
|---|---|---|---|
| | (reactor grade) + | (reactor grade) + | Low MFR PP (reactor |
| | 5 wt. % | 7.5 wt. % | grade) + 10 wt. % |
| Property | PB0800M | PB0800M | PB0800M |
| MFR (2.16 kg/230 C.) dg/min | 2.2 | 2.3 | 2.2 |
| Spiral length at 60 bar, 200 C. | 120 | 120 | 130 |
| (mm) | | | |
| Spiral length at 100 bar, | 205 | 200 | 210 |
| 200 C. (mm) | | | |

Applicants presently believe that Example 6 Experiment 1 illustrates that the addition of PB-1 to a PP results in a modest increase in MFR (as compared to visbreaking), and an improvement in spiral flow.

In Example 6 Experiment 2, the spiral lengths of a polypropylene reactor grade raco resin were observed before and after visbreaking as follows:

| | RACO PP | Visbroken RACO PP |
|---|---|---|
| | (commercially | (commercially |
| | available as RP448S | available as |
| Property | from LYB) | RP591V from LYB) |
| MFR (2.16 kg/230 C.) | 39 | 97 |
| dg/min | | |
| Spiral length at 1000 PSI, | 19 | 23 |
| 430 F. (in) | | |

In Example 6 Experiment 2, the same RACO (RP448S) was blended in two respective amounts (to produce two different samples). The first blend included 5 weight percent PB1 (PB0800M), and the second blend included 10 weight percent PB0800M; and resulted in the following properties:

| | RP448S RACO | RP448S |
|---|---|---|
| | PP + 5 wt. % PB-1 | RACO PP + 10 |
| Property | 0800M | wt. % PB-1 0800M |
| MFR (2.16 kg/230 C.) dg/min | 44.7 | 48.9 |
| Spiral length at 1000 PSI, | 19.7 | 21.9 |
| 430 F. (in) | | |
| Projected MFR from spiral | 49 | 81 |
| length | | |

Applicants presently believe that Example 6 Experiment 2 illustrates that the inclusion of PB1 yields a significant flow improvement with a smaller effect on MFR.

Alternative embodiments of PB-1 incorporated into HECO polypropylene resins and the resulting MFR is as follows:

| | Ex A | Ex B | Ex C | Ex D | Ex E |
|---|---|---|---|---|---|
| PP HECO | 100% | 95% | 90% | 80% | 80% |
| PBM1200M | | 5% | 10% | 20% | |
| PBM0700M | | | | | 20% |
| MFR (230 C.) | 0.8 | 0.9 | 1.3 | 8.7 | 4.1 |

PBM1200M is a RACO with an MFR of 1200 at 190° C. 2.16 kg (g/10min); a Tₘ₁ of 102° C.; and a flexural modulus 339 (MPA). PBM0700M is a RACO with an MFR of 750 at 190° C. 2.16 kg (g/10min); a Tₘ₁ of 88; and a flexural modulus 88 (MPA).

### Example 7

### PB-1 Facilitates the Migration of Fluorinated Additives to the Surface in PP Fibers

Applicants presently belief that PB1 may act as a migration promotor of additives. Fluorochemical surface-modifying additives may be found in the textile, nonwoven, carpet, leather and paper industries. PB-1 may be used as a component of such fluorinated masterbatches, and may facilitate the migration of expensive fluorinated additives to the surface in PP fibers. This may result in needing less fluoro-additives than would otherwise be needed to achieve the same fiber end performance (and reducing the overall cost of the fiber). By way of background, a combination of FC-1296 and PB0400 could be used. Full absorption could be achieved prior to reaching max speed of wetting. Both additives could be added in a masterbatch. Such was the result of experiments done by Johan DeWitte and published in the Nonwovens World issue February-March 2001.

### Example 8

### PB-1 as a carrier of nanoclay masterbatches

In an embodiment, nanoclays may be thermally sensitive and difficult to disperse in the polymer matrix. Applicants presently believe that PB-1 can be used as a carrier for the nanclay masterbatches. Subsequently PB-1 based nanocomposites may be added to enhance the properties of the polypropylene films and fibers. Examples follow:

| | | | |
|---|---|---|---|
| PP fiber grade wt % | 100 | 99 | 96 |
| Nano PB-1 | 0 | 1 | 4 |
| masterbatch wt % | | | |
| Tenacity, cN/tex | 24.1 | 28.1 | 33.4 |
| Elongation at break % | 240 | 255 | 265 |
| Softness | Low softness | Medium softness | High softness |

### Example 9

### PB-1 as a Carrier for Peroxide Masterbatches

Applicants presently believe that PB-1 may be a carrier of peroxide masterbatch, which may be used to increase the MFR of PP grades. Applicants further believe that due to the low melting temperature, shear sensitivity and low heat of fusion, PB 1 can be processed at relatively mild conditions. Applicants further believe that PB-1 may be used as a carrier in peroxide masterbatches to allow to encapsulate the peroxide in polymer without activating the peroxide. Applicants further believe that the peroxide masterback based on PB-1 may be used to crack PP by increasing the MFR of the fiber grades to 1200 MFR for meltblown applications. Applicants further believe that PB also provides the polymer an elasticity and soft touch, and improved weld ability to PP fiber grades.

PB-1 (high MFR grade PB0801M) may be used as part of the carrier in the pigment masterbatch, which may reduce the presence of pigment agglomerates. PB0800M may be used as a carrier resin for the TiO₂-MB to provide the highest color yield with the lowest allogmerates. PB-1 may help pigment dispersion of organic red when used as a masterbatch carrier resin. PB-1 may be a migration promoter of additives (because PB-1 is more polar compared to PE or PP and because PB-1 accelerates the migration of fluorochemical surface-modifying additives to the surface of PP fibers). PB-1 may improve the flowability of low MFR polymers while maintaining good mechanical properties so that the visbreaking or cracking isn't needed (or can be reduced). PB-1 can be used a property modifier in PP (increase flexibility, lower SIT, etc). PB-1 may result in good retention of optical properties in BOPP using copolymers (without negative effects on clarify and haze by using up to about 30 wt % of PB-1). PB-1 may improve creep resistance of blown-PE film. PB-1 may have a limited influence of fillers on flow behavior. PB-1 can be used as an ESCR improver as it does not show any failures after 15,000 hours immersion in 10% lgepal C0630 solution at 50° C. (ASTM D1693).

Accordingly, PB-1 may be used in pipes and pressure tanks because of its creep resistance properties. PB-1 may be used in powder coatings and boilers because of its ESCR enhancing properties. PB-1 may be used in compounds, MBs and fibers because of its rheological behavior. PB-1 may be used fibers and hot melt adhesives because of its slow crystallization. PB-1 may be used in easy opening packaging because of its disperse-ability in PE. PB-1 may be used in compounds, MBs and PP modifications because of its compatibility with PP. PB-1 may be used in adhesives because of its good molecular cohesion. PB-1 may be used in hoses, mining, and TPV because of its wet abrasion resistance properties. PB-1 may be used in various applications because it is flexible without a rubber phase. PB-1 may be used to minimize (or reduce) the re-agglomeration of fillers and pigments in a polymer composition that can cause gels and surface roughness in the finished article (because PB-1 may melt first in the extruder and act to coat filler particles).

The terms “a,” “an,” and “the” are intended to include plural alternatives, e.g., at least one. For instance, the disclosure of “a 1-butene polymer”, “a polypropylene,” “an additive,” and the like, is meant to encompass one, or combinations of more than one 1-butene polymer, polypropylene, additive, and the like, unless otherwise specified.

In the descriptions provided herein, the terms “includes,” “is,” “containing,” “having,” and “comprises” are used in an open-ended fashion, and thus should be interpreted to mean “including, but not limited to.” When methods or compositions are claimed or described in terms of “comprising” various components or steps, the methods or compositions can also “consist essentially of” or “consist of” the various components or steps, unless stated otherwise.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in one embodiment, that the 1-butene polymer is present in the composition at an amount of about 5% to about 20% by weight, based on the weight of the composition. This range should be interpreted as encompassing amounts of about 5% to about 20%, and further encompasses “about” each 6%, 7%, 8%, 9%, 10%, 11%, 12%, 13%, 14%, 15% 16% 17% 18%, and 19%, including any ranges and sub-ranges between any of these values.

The term “about”, as used herein, refers to values that are within 5% of the indicated value. For example, “about 10%” would encompass 9.5% to 10.5%.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims.

What is claimed is:

1. A composition comprising:
a 1-butene polymer;
a pigment; and
a polypropylene;
wherein the 1-butene polymer is present in the composition at an amount of about 5% to about 20% by weight, based on the weight of the composition,
wherein the pigment is present in the composition at an amount of about 10% to about 45% by weight, based on the weight of the composition; and
wherein the polypropylene is present in the composition at an amount of about 25% to about 85% by weight, based on the weight of the composition.

2. The composition of claim 1, wherein the pigment is in a particulate form having an average particle size of about 5 μm to about 55 μm.

3. The composition of claim 1, wherein the pigment is in a particulate form having an average particle size of about 10 μm to about 30 μm.

4. The composition of claim 1, further comprising one or more additives, wherein the one or more additives are present in the composition at an amount of about 0.01% to about 10% by weight, based on the weight of the composition.

5. The composition of claim 4, wherein the one or more additives is selected from a stabilizer, a nucleating agent, a slip agent, an antiblocking agent, a lubricant, an antistatic agent, a modifier of molecular weight, a modifier of one or more rheological properties, or a combination thereof.

6. The composition of claim 1, wherein the 1-butene polymer has a melt flow rate of about 0.1 to about 3000 g/10 min at a temperature of 190° C. and a load of 2.16 kg and a density of about 0.915 g/cm³.

7. A method of dispersing a pigment and/or filler in a polymer composition, the method comprising
providing a polymer composition comprising a pigment, a filler, or a combination thereof; and
contacting the polymer composition with a non-blooming dispersion aid to form a modified polymer composition, wherein the non-blooming dispersion aid comprises a 1-butene polymer;
wherein the polymer composition has one or more surface characteristics that are substantially identical to one or more surface characteristics of the modified polymer composition.

8. The method of claim 7, wherein the polymer composition comprises polypropylene, and the polypropylene is present in the polymer composition at an amount of at least 50% by weight, based on the weight of the polymer composition.

9. The method of claim 7, wherein the 1-butene polymer has a melt flow rate of about 0.1 to about 3000 g/10 min at a temperature of 190° C.; a load of 2.16 kg; and a density of about 0.915 g/cm³.

10. A method of modifying a polymer composition, the method comprising:
providing a polymer composition comprising a pigment, a filler, or a combination thereof, wherein the pigment, the filler, or a combination thereof have a first propensity to agglomerate;
contacting the polymer composition with a 1-butene polymer to form a modified polymer composition, wherein the pigment, the filler, or a combination thereof have a second propensity to agglomerate in the modified polymer composition, wherein the second propensity to agglomerate is less than the first propensity to agglomerate.

11. The method of claim 10, wherein the polymer composition comprises polypropylene, and the polypropylene is present in the polymer composition at an amount of at least 50% by weight, based on the weight of the polymer composition.

12. The method of claim 10, wherein the 1-butene polymer has a melt flow rate of about 0.1 to about 3000 g/10 min at a temperature of 190° C.; a load of 2.16 kg; and a density of about 0.915 g/cm³.

13. An article comprising a composition of claim 1, wherein the composition comprises:
the 1-butene polymer;
the pigment;
the polypropylene; and
optionally one or more additives;
wherein the 1-butene polymer is present in the composition at an amount of about 5% to about 20% by weight, based on the weight of the composition,
wherein the pigment is present in the composition at an amount of about 10% to about 45% by weight, based on the weight of the composition;
wherein the polypropylene is present in the composition at an amount of about 25% to about 85% by weight, based on the weight of the composition;
wherein the pigment is in a particulate form having an average particle size of about 5 μm to about 55 μm; and
wherein the one or more additives are present in the composition at an amount of about 0% to about 10% by weight, based on the weight of the composition.
